(19) United States
(12) Patent Application Publication
(10) Pub. No.: US 2004/0198255 A1
(43) Pub. Date: Oct. 7, 2004

(54) In-vehicle wireless device, management center, and operating-state notification system

(76) Inventor: Atsushi Hayashida, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/378,207

(22) Filed: Mar. 3, 2003

(30) Foreign Application Priority Data
Mar. 22, 2002 (JP) 2002-81278

(51) Int. Cl. H04B 1/034

(52) U.S. Cl. 455/99; 455/556.1

(57) ABSTRACT

An in-vehicle wireless device mounted in a vehicle detects an operating state of an on-state and an off-state of an ignition of the vehicle. The in-vehicle wireless device shifts an operating state of a wireless section for wireless communication between an on-state and an off-state during the off-state of the ignition. The in-vehicle wireless device simultaneously notifies the operating state of the wireless section to a management center. The management center then notifies to a cell phone of a vehicle user the received operating state of the wireless section of the in-vehicle wireless device.

### CROSS REFERENCE TO RELATED APPLICATIONS

This application is based on and incorporates herein by reference Japanese Patent Application No. 2002-81278 filed on Mar. 22, 2002.

### FIELD OF THE INVENTION

The present invention relates to an in-vehicle wireless device, a management center that manages an operating state of the in-vehicle wireless device, and an operating-state notification system including the in-vehicle wireless device and the management center. These are useful especially for providing telematics services with enhancing convenience for a user of the telematics services.

### BACKGROUND OF THE INVENTION

An in-vehicle wireless device or a telematics device provides so-called telematics service by being integrated with a global positioning system (GPS), a wireless mobile phone, the Internet and others. The telematics services include a stolen-car position notification service that a present position of a stolen car is notified to a user, a remote horn-sounding service that a vehicle is found in a parking lot by sounding a horn, and a door-unlock service that a locked vehicle door is remotely unlocked by a management center. These services are realized by the in-vehicle wireless device that controls in-vehicle information devices and in-vehicle control devices based on communication with the outside of the vehicle through a cell phone network.

The in-vehicle wireless device must be capable of receiving wireless signals even during an off-state of main power of the vehicle. Simultaneously, the in-vehicle wireless device naturally needs to lower power consumption as much as possible during the off-state of the main power of the vehicle.

To attain these requirements, the in-vehicle wireless device is periodically turned on during the off-state of the main power.

However, when the in-vehicle wireless device happens to be turned off, a remote command for executing a service from a cell phone of the user cannot be received. The user thereby waits for the in-vehicle wireless device to be next turned on.

The above telematics services are typically used when the user is located remotely from the vehicle. The user cannot recognize an operating state whether the in-vehicle wireless device is in an on-state or an off-state (or turned on or off), so that the user cannot estimate when the service is to be executed. This results in providing an inconvenient and inefficient service to the user.

### SUMMARY OF THE INVENTION

It is an object of the present invention to enable a user to recognize an operating state of an in-vehicle wireless device that is periodically turned on during an off-state of main power of a vehicle.

To achieve the above object, a wireless device is provided with the following. The wireless device detects either of an on-state and an off-state of main power of a vehicle. It includes a wireless section whose operating state being shifted between an on-state and an off-state during the off-state of the main power of the vehicle. It notifies to a center wireless-state information that includes information relating to the operating state of the wireless section. By contrast, the center is provided with the following. The center determines whether the wireless-state information is notified by the wireless device. It then notifies to the user the wireless-state information. This structure enables the user to recognize the operating state of the wireless device during the off-state of the main power of the vehicle.

It is preferable that the center furthermore stores the wireless-state information received from the wireless device and notifies, according to request of the user, to the user the wireless-state information.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of an operating-state notification system according to a first embodiment of the present invention;

FIG. 2 is a structural block diagram of a management center according to the first embodiment;

FIG. 3 is a structural block diagram of a wireless device according to the first embodiment;

FIG. 4 is a flowchart diagram explaining periodic-operation processing of a wireless-control CPU of the wireless device according to the first embodiment;

FIG. 5 is a table showing a database stored in a center memory of the management center according to the first embodiment;

FIG. 6 is a flowchart diagram explaining timing notification processing of a control CPU of the wireless device according to the first embodiment;

FIG. 7 is a flowchart diagram explaining user notification processing of a center CPU of the management center according to the first embodiment; and

FIG. 8 is a schematic view of an operating-state notification system according to a second embodiment.

### DETAILED DESCRIPTION OF THE PREFERRED EMBODIMENTS

### (First Embodiment)

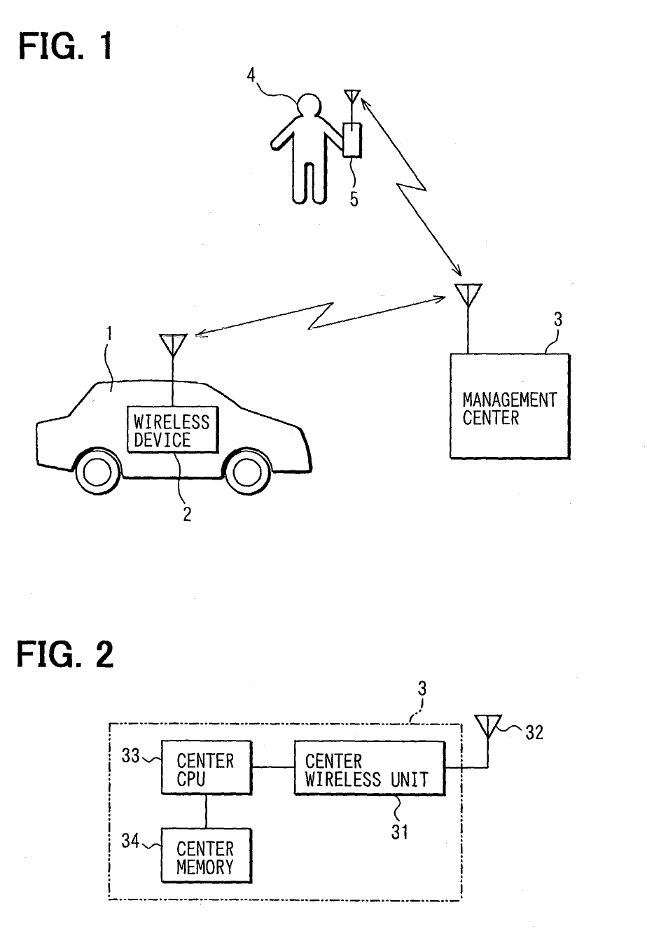

Referring to FIG. 1, an operating-state notification system includes a vehicle 1, a wireless device 2 mounted in the vehicle 1, a management center 3, a cell phone 5 that a user 4 possesses. In the operating-state notification system, the wireless device 2 mounted in the vehicle 1 notifies an operating state of its own to the management center 3, while the management center 3 notifies the operating state of the wireless device 2 to the cell phone 5 of the user 4.

The wireless device 2 as a so-called telematics device is mounted in the vehicle 1 owned by the user 4 who uses telematics services.

Referring to FIG. 2, the management center 3 includes a center wireless unit 31, a center antenna 32, a center CPU 33, and a center memory 34.

The center wireless unit 31 transmits a transmission signal to the center antenna 32. It also receives a reception signal from the center antenna 32. It exchanges the transmission signal and the reception signal with the center CPU 33. The center CPU 33 controls the center wireless unit 31 to execute wireless communication.

The center antenna 32 converts the transmission signal outputted from the center wireless unit 31 to a transmission wireless signal to transmit while the center antenna 32 converts a reception wireless signal to the reception signal to output to the center wireless unit 32.

The center CPU 33 generates the transmission signal to output to the center wireless unit 31. It also receives the reception signal from the center wireless unit 31 and executes processing based on the reception signal. The center CPU 33 stores in the center memory 34, which is a storing device, information notified by the wireless device 2 of the vehicle 1, and reads out the stored information to notify to the user 4.

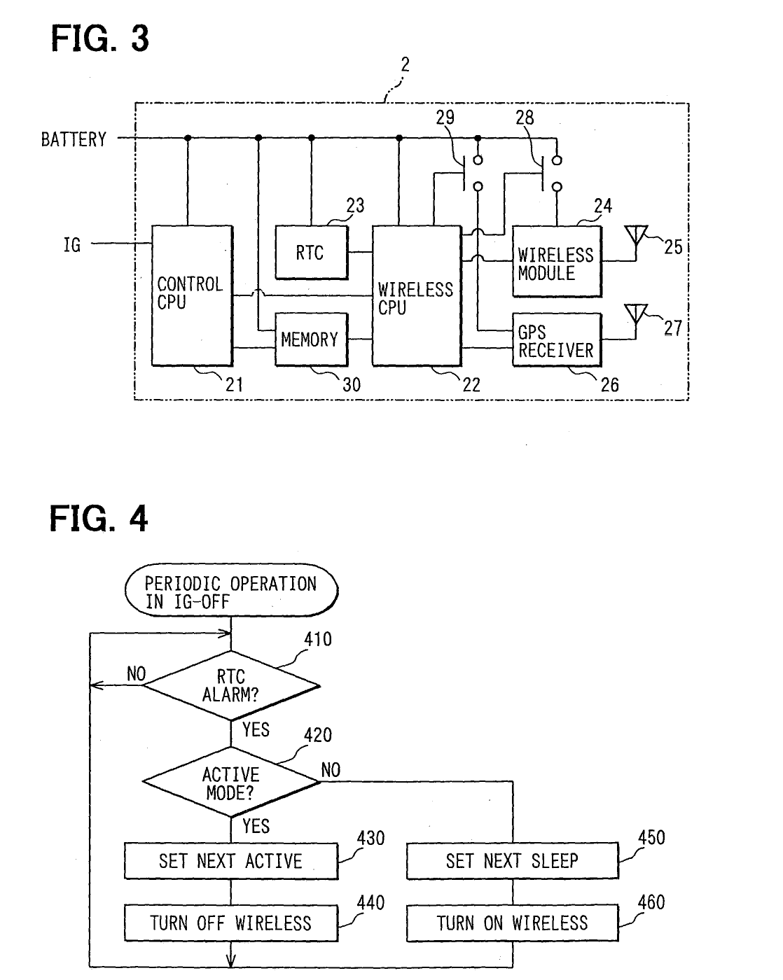

Referring to FIG. 3, the wireless device 2 includes a control CPU 21, a wireless-control CPU 22, a real time clock (RTC) 23, a wireless module 24, a wireless antenna 25, a global positioning system (GPS) receiver 26, a GPS antenna 27, switches 27, 28 and a memory 30. These constituent elements of the wireless device 2 can be supplied with a battery power to be operable even during an off-state of an ignition (IG) of the vehicle 1.

The control CPU 21 operates based on predetermined software to execute for the various telematics services. The control CPU 21 detects an on-state or off-state of the IG of the vehicle 1. The control CPU 21 exchanges a control signal and an information signal with the wireless-control CPU 22. The control CPU 21 controls the wireless-control CPU 22 and detects an operating state of the wireless-control CPU 22. The control CPU 21 also controls in-vehicle devices such as a door-lock device through an in-vehicle local area network (in-vehicle LAN) (not shown). The control CPU 21 stores and reads out information in the memory 30 if necessary.

The wireless-control CPU 22 executes processing for receiving and transmitting the wireless signal. It exchanges with the wireless module 24 signals for receiving and transmitting the wireless signal and controls the wireless module 24. The wireless-control CPU 22 controls the GPS receiver 26 to receive a present position of the vehicle 1 from the GPS receiver 26. The wireless-control CPU 22 is controlled by the control CPU 21 and detects the operating state of the control CPU 21. The wireless-control CPU 22 controls the RTC 23 and if necessary stores and reads out information in the memory 30. The wireless-control CPU 22 controls the switches 28, 29 to control an on-state or off-state of the wireless module 24 and antenna 25, or the GPS receiver 26 and the GPS antenna 27, respectively.

The wireless-control CPU 22 stays in either an active mode, where a normal operation is executed, or an sleep mode, where limited processing such as processing of transferring to the active mode with receiving a predetermined signal. The wireless-control CPU 22 shifts from the active mode into the sleep mode via predetermined processing, which will be explained below, by receiving an alarm signal from the RTC 23. The wireless-control CPU 22 shifts from the sleep mode into the active mode via wake-up processing by receiving the alarm signal from the RTC 23. The wireless-control CPU 22 controls the wireless module 24 and antenna 25 to be shifted in the on-state by shifting the switch 28 to the on-state in the active mode. By contrast, the wireless-control CPU 22 controls the wireless module 24 and antenna 25 to be shifted in the off-state by shifting the switch 28 to the off-state in the sleep mode.

The RTC 23 is a real time clock including a counter (not shown) that measures time. The RTC 23 expires when it reaches a viable predetermined setting time and outputs the alarm signal to the wireless-control CPU 22. The predetermined setting time is set by the control signal from the wireless-control CPU 22.

The wireless module 24 which is controlled by the wireless-control CPU 22 modulates the transmission signal to the wireless signal and demodulates the wireless signal to the reception signal.

The GPS receiver 26 is controlled by the wireless-control CPU 22 to obtain present position information regarding its own present position by receiving information from GPS satellites through the GPS antenna 27. The GPS receiver 26 then outputs the present position information to the wireless-control CPU 22.

A stolen-car position notification service among the telematics services is operated using the above wireless device 2 as below. When the user 4 recognizes that the vehicle 1 is stolen, the user 4 calls in a stolen-car notification center (not shown) via a phone or the Internet. The stolen-car notification center then communicates with the wireless device 2 mounted in the vehicle 1 by wireless to request the wireless device 2 to notify the present position information of the vehicle 1. Based on the request of the stolen-car notification center, the wireless device 2 transmits, using the wireless module 24, to the stolen-car notification center the present position information of the vehicle 1 which is obtained from the GPS receiver 26. When the stolen-car notification center receives the present position information of the vehicle 1, it notifies the present position information to the user 4. The user 4 can hence know the present position of the stolen vehicle 1.

A door-unlock service among the telematics services is operated as below. When the user 4 locks the doors of the vehicle 1 with leaving a key of the vehicle 1 inside the vehicle 1, the user 4 calls in a telematics service center via the phone or the Internet. The telematics service center then communicates with the wireless device 2 mounted in the vehicle 1 by wireless to request the wireless device 2 to unlock the doors of the vehicle 1. Based on the request of the telematics service center, the wireless device 2 controls the door-lock device through the in-vehicle LAN to unlock the doors. The user 4 can hence open the doors of the vehicle 1.

The above telematics services can be operated only when the wireless device 2 of the vehicle 1 is capable of receiving the wireless signal even during the off-state of the IG. The wireless-control CPU 22 of the embodiment periodically shifts to and from the active mode and the sleep mode during the off-state of the IG. According to shifting to and from the active mode and the sleep mode of the wireless-control CPU 22, the wireless module 24 shifts to and from the on-state and the off-state, while the GPS receiver 26 is turned on only when it is necessary. Thus a wireless section, which includes the wireless module 24, the wireless antenna 25, the GPS receiver 26, and the GPS antenna 27, periodically shifts to and from the on-state and the off-state (periodically turns on or turns off), and can receive the wireless signal in the on-state.

Periodic-operation processing, during the off-state of the IG, of the above wireless section of the wireless device 2 is controlled by the wireless-control CPU 22, and is explained below, referring to FIG. 4.

At Step 410, when the wireless-control CPU 22 determines that the RTC 23 outputs the alarm signal by reaching the predetermined setting time, the processing proceeds to Step 420.

At Step 420, whether the wireless-control CPU 22 itself stays either in the active mode or in the sleep mode is determined. When the wireless-control CPU 22 is determined to be in the active mode, the processing proceeds to Step 430. Here, time to the next active mode when the RTC 23 outputs the next alarming signal, for instance fifteen minutes, is set by controlling the RTC 23. Simultaneously the time to the next active mode is notified to the control CPU 21. Then, at Step 440, the wireless-control CPU 22 turns off the switch 28 and shifts into the sleep mode. The processing then returns to Step 410 where the wireless-control CPU 22 waits for the alarm signal from the RTC 23.

At Step 420, when the wireless-control CPU 22 is determined to be in the sleep mode, the processing proceeds to Step 450. Here, time to the next sleep mode when the RTC 23 outputs the next alarming signal, for instance five minutes, is set by controlling the RTC 23. Simultaneously the time to the next sleep mode is notified to the control CPU 21. Then, at Step 460, the wireless-control CPU 22 turns on the switch 28 and shifts into the active mode. The processing then returns to Step 410 where the wireless-control CPU 22 waits for the alarm signal from the RTC 23.

Through the above looped processing of the periodic operation, by receiving the alarm signal from the RTC 23, the wireless-control CPU 22 in the active mode shifts into the sleep mode. Simultaneously, the wireless-control CPU 22 sets the time to the next active mode to the RTC 23 along with turning off the wireless section (shifting the wireless section into the off-state). By contrast, by receiving the alarm signal from the RTC 23, the wireless-control CPU 22 in the sleep mode shifts into the active mode. Simultaneously, the wireless-control CPU 22 sets the time to the next sleep mode to the RTC 23 along with turning on the wireless section (shifting the wireless section into the on-state).

As explained above, during the off-state of the IG, the wireless section shifts to and from the on-state and the off-state by the control of the wireless-control CPU 22. This enables the wireless device 2 to periodically receive the wireless signal by using the wireless section, and the control CPU 21 to know when the next active or sleep mode of the wireless-control CPU 22 starts.

When the IG is turned on, the wireless-control CPU 22 is controlled by the control CPU 21 to shift and stay in the active mode irrespective of the alarming signal from the RTC 23. Here, the wireless-control CPU 22, along with the above processing, executes processing for the telematics services and other communication processing.

Under the above periodic operation of the wireless section of the wireless device 2, when the user 4 transmits, for using the telematics services, a command from a cell phone 5 to the vehicle 1, for instance, through the stolen-car notification center, the user 4 must wait for the wireless section of the wireless device 2 to be next turned on to execute the command. When the user 4 remotely located from the vehicle 1 uses the telematics services, the user 4 cannot directly recognize information of the operating state of the wireless device 2 during the off-state of the IG.

To solve the above issue, in the embodiment, the wireless device 2 notifies to the management center 3 the information of the operating state of the wireless section and the IG of the vehicle 1. The information of the operating state of the wireless section includes a present operating state of the on-state or the off-state, and timing when the wireless section is next shifted into the other state. The management center 3 notifies to the user 4 the information of the operating state in two notification ways of quick notification and inquiry-based notification as below.

In the quick notification way, as soon as the management center 3 is notified of the information of the operation state, the management center 3 notifies the information of the operation state to the user 4. In the inquiry-based notification way, the management center 3 at once stores the information of the operating state from the wireless device 2, and notifies the stored information of the operating state to the user 4 when the user 4 requests the information of the operating state. Each user 4 previously registers which notification way should be used. This registration is stored and read out in and from the center memory 34 in the management center 3.

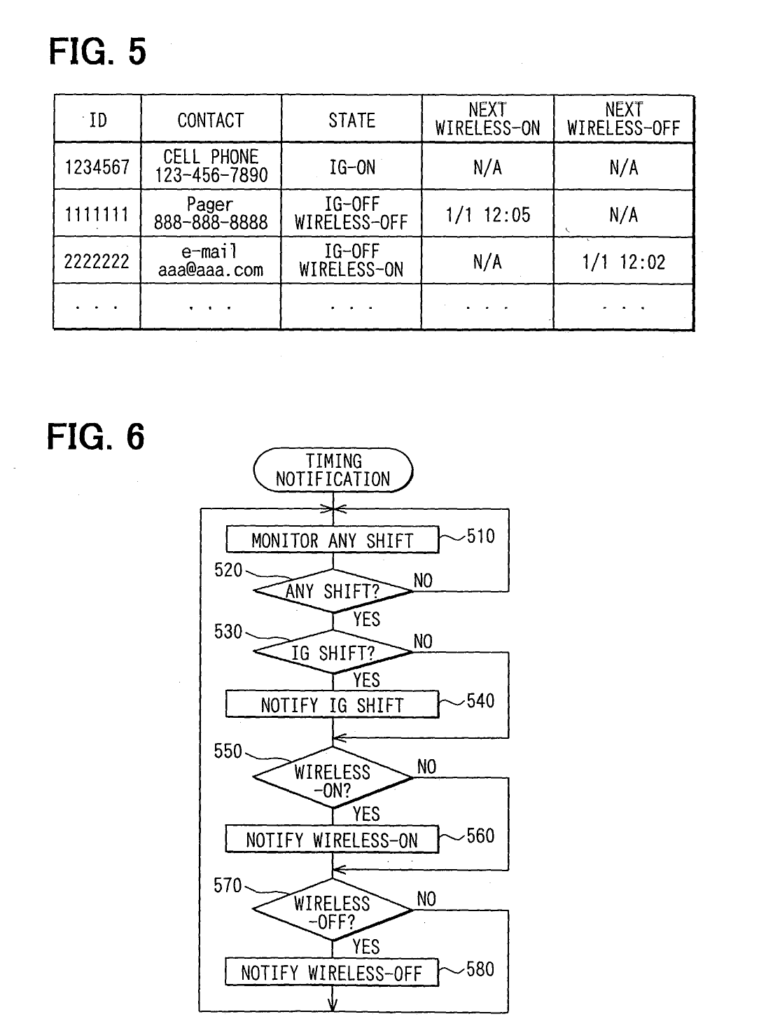

The management center 3 stores the information of the operating state of the wireless device 2 as a database in the center memory 34. An instance of a format of the database is shown in FIG. 5. The information of the operating state of the wireless device 2 mounted in each vehicle 1 is shown in each row from the second row. Each row includes an identification number (ID) of the vehicle 1, contact information of the user 4, and the information of the operating state of the wireless section of the wireless device 2. The ID includes a phone number of the wireless device 2 and a body number of the vehicle 1. The contact information of the user 4 includes a cell phone number, a facsimile number, a pager number, an email address of the user 4.

The information of the operating state of the wireless device 2 is shown in three columns between the third column and the fifth column from the left. In the third column, the operating states of the IG and wireless section of the wireless device 2 are shown. In the fourth column, during the off-state of the IG, next on-state timing when the wireless section is next shifted into the on-state is shown. In the fifth column, during the off-state of the IG, next off-state timing when the wireless section is next shifted into the off-state is shown. Here, the next on-state timing and the off-state timing can be either notified by the wireless device 2 or estimated in the management center 3 based on the notification of the operating states from the wireless device 2. A sign of N/A indicates that information is not available. As explained above, the management center 3 stores information relating to a plurality of the wireless devices 2 of the vehicles 1.

Referring to FIG. 6, timing notification processing of the control CPU 21 will be explained below. The timing notification processing is executed by the control CPU 21 for the wireless device 2 to notify to the management center 3 of the information of the operating state of the wireless device 2.

At Step 510, the control CPU 21 simultaneously monitors any state shift of the wireless device 2 after a start of the timing notification processing.

At Step 520, whether any state shift of the wireless device 2 is generated is determined. When any state shift is determined to be not generated, the processing returns to Step 510. When any state shift is determined to be generated, the processing proceeds to Step 530.

At Step 530, whether the state of the IG is shifted is determined. When the state of the IG is determined to be shifted, the processing proceeds to Step 540. Here, the control CPU 21 controls the wireless-control CPU 22 to notify to the management center 3 that the state of the IG is shifted and which state the IG is in at present. When the state of the IG is determined to be not shifted or when the processing at Step 540 is completed, the processing proceeds to Step 550.

At Step 550, whether the wireless section is shifted into the on-state is determined by detecting the state of the wireless-control CPU 22. When the wireless section is determined to be shifted into the on-state, the processing proceeds to Step 560. Here, the control CPU 21 controls the wireless-control CPU 22, to notify to the management center 3, that the wireless section is shifted into the on-state and when the wireless section is to be next shifted into the off-state. The notification includes the ID of the vehicle 1 and the contact information of the user 4. When the wireless section is determined to be not shifted into the on-state or when the processing at Step 560 is completed, the processing proceeds to Step 570.

At Step 570, whether the wireless section is going to be shifted into the off-state, for instance in three seconds, is determined by detecting the state of the wireless-control CPU 22. When the wireless section is determined to be going to be shifted into the off-state, the processing proceeds to Step 580.

At Step 580, the control CPU 21 controls the wireless-control CPU 22 to notify to the management center 3 that the wireless section is going to be shifted into the off-state and when the wireless section is to be next shifted into the on-state. The notification includes the ID of the vehicle 1 and the contact information of the user 4. When the wireless section is determined to be going to be not shifted into the off-state or when the processing at Step 560 is completed, the processing returns to Step 510.

As explained above, although three notifications at Steps 540, 560 and 580 are executed, three notifications are not always necessary. For instance, two notifications at Steps 560 and 580 can be efficient as the timing notification processing.

The control CPU 21 executes other processing for the telematics services along with the above timing notification processing.

Thus, by the control of the control CPU 21, the wireless-control CPU 22 can notify to the management center 3 the information of the operating state of the wireless device 2 of the vehicle 1.

The management center 3 then notifies the user 4 of the information of the operating state received from the wireless device 2. This user notification processing is executed as below by the center CPU 33 in the management center 3.

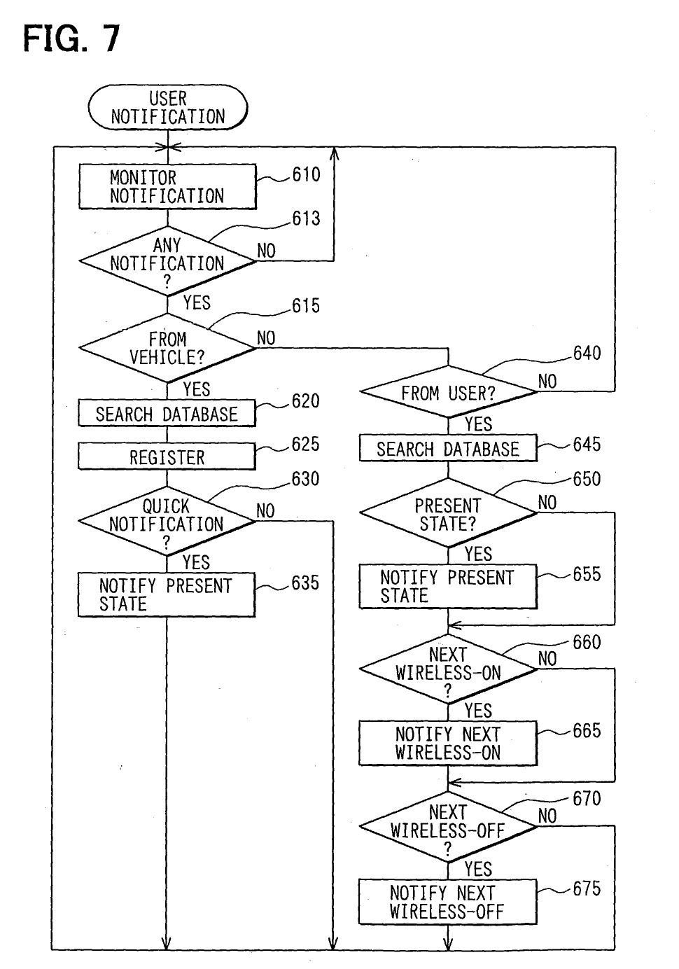

Referring to FIG. 7, at Step 610, the center CPU 33 monitors any notification through the center wireless unit 31.

At Step 613, whether certain notification is monitored is determined. When the certain notification is determined to be monitored, the processing proceeds to Step 615. When the certain notification is determined to be not monitored, the processing returns to Step 610.

At Step 615, whether the information of the operating state is notified from the vehicle 1 is determined. When the information of the operating state is determined to be notified from the vehicle 1, the processing proceeds to Step 620.

At Step 620, the database shown in FIG. 5 is read out from the center memory 34 and searched for the registration corresponding to the ID of the vehicle 1 included in the received notification. At Step 625, the notified information of the operating state of the wireless device 2 of the vehicle 1 is registered in the corresponding registration.

At Step 630, whether the quick notification way is registered by the user 4 of the corresponding registration is determined by referring to the registration stored in the center memory 34. When the quick notification way is determined to be registered, the processing proceeds to Step 635, where the center CPU 33 controls the center wireless unit 31 to transmit to the user contact information the updated information of the operating state of the wireless device 2. When the quick notification way is determined to be not registered and the processing at Step 635 is completed, the processing returns to Step 610.

By contrast, at Step 630, when the information of the operating state is determined to be not notified from the vehicle 1, the processing proceeds to Step 640.

At Step 640, whether the inquiry is notified from the user 4 is determined. When the inquiry is determined to be not notified from user 4, the processing returns to Step 610. When the inquiry is determined to be notified from the user 4, the processing proceeds to Step 645.

At Step 645, the database is searched for the registration corresponding to the user 4 who transmits the inquiry.

At Step 650, whether the inquiry is relating to the present operating state of the wireless section of the wireless device 2 is determined. When the inquiry is determined to be relating to the present operating state, the processing proceeds to Step 655, where the center CPU 33 notifies to the user 4 the corresponding present operating state of the wireless section in the database. When the inquiry is determined to be not relating to the present operating state and the processing at Step 655 is completed, the processing proceeds to Step 660.

At Step 660, whether the inquiry is relating to the next shift to the on-state of the wireless section is determined. When the inquiry is determined to be relating to the next shift to the on-state of the wireless section, the processing proceeds to Step 665.

At Step 665, the center CPU 33 notifies to the user 4 the next on-state timing when the wireless section is next shifted into the on-state in the database. When the inquiry is determined to be not relating to the next shift to the on-state of the wireless section and the processing at Step 665 is completed, the processing proceeds to Step 670.

At Step 670, whether the inquiry is relating to the next shift to the off-state of the wireless section is determined. When the inquiry is determined to be relating to the next shift to the off-state of the wireless section, the processing proceeds to Step 675.

At Step 675, the center CPU 33 notifies to the user 4 the next off-state timing when the wireless section is next shifted into the off-state in the database. When the inquiry is determined to be not relating to the next shift to the off-state of the wireless section and the processing at Step 675 is completed, the processing returns to Step 610.

As explained above, by the control of the center CPU 33, the management center 3 can notify to the user 4 the information of the operating state of the wireless section of the wireless device 2 based on the notification from the wireless device 2.

The notification way, the quick notification or the inquiry-based notification, is previously registered by the user 4 so that the management center 3 can select the notification way according to the user's registration.

### (Second Embodiment)

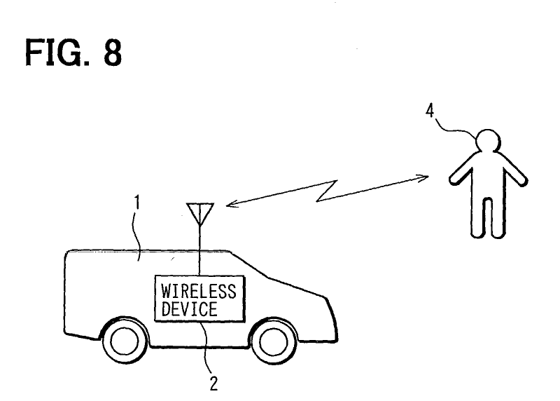

In a second embodiment, as shown in FIG. 8, an operating-state notification system includes a vehicle 1 possessed by a user 4 and a wireless device 2 mounted in the vehicle 1, without the management center 3 included in the first embodiment. In this operating-state notification system, the wireless device 2 mounted in the vehicle 1 directly notifies to the user 4 information of its own operating state.

The wireless device 2 has the same structure as that of the wireless device 2 of the first embodiment shown in FIG. 3.

Periodic-operation processing, during the off-state of the IG, of the wireless section of the wireless device 2 is controlled by a wireless-control CPU 22 in similarity with that of the first embodiment shown in FIG. 4.

As explained above, the information of the operating state of the wireless devices 2 is notified to the user 4 instead of the management center 3. The processing of the control CPU 21 is therefore the same as that of the first embodiment shown in FIG. 6, except that the information of the operating state is notified to the user 4 instead of the management center 3.

The notification to the user 4 from the wireless device 2 is executed through one of communication methods such as a cell phone, a facsimile, a pager, or an email. An address relating to each method is stored in the memory 30 of the wireless device 2.

### (Modification)

The first and second embodiments can be modified below.

A user can include not only an owner of a vehicle but also a person who is authorized to use the vehicle.

A vehicle having a wireless device can be not only an automobile but also a ship or a motorcycle.

Although an operating state of a main power corresponds to one of an IG, it can correspond to one of an accessory switch that allows powering to accessory components. It can be furthermore an operating state of a switch that allows an engine to start in a diesel engine, a switch that allows a driving motor to start in an electric vehicle, or a switch that allows a motor to start in a mobile object.

Each processing shown in the flowcharts can be materialized by not only a software method but also a dedicated hardware method.

In the first embodiment, the management center 3 communicates with the wireless device 2 and the cell phone 4 of the user 4 through the wireless unit 31. However, the management center 3 can also communicates with them, without the wireless unit 31, by using a wired phone line connecting with networks of the cell phone 4 and the wireless device 2.

In the first embodiment, the management center 3 can be mounted in the vehicle 1, along with the wireless device 2. Here, the wireless module 24 can be used as the center wireless unit 31, and the memory 30 can be used as the center memory 34. Furthermore, the wireless device 2 and the center 3 can communicate with each other even through the in-vehicle LAN.

What is claimed is:

1. A wireless device that is provided in a vehicle and communicates with a center that communicates with a user, the wireless device comprising:
power detecting means for detecting either of an on-state and an off-state of main power of the vehicle;
wireless means, for wireless communication, having periodic-operation means that shifts an operating state of the wireless means itself between an on-state and an off-state during the off-state of the main power of the vehicle detected by the power detecting means; and
notifying means for notifying to the center wireless-state information including information that relates to the operating state of the wireless means, wherein the center then notifies the wireless-state information to the user.

2. A wireless device according to claim 1,
wherein the wireless-state information notified to the center by the notifying means includes that the wireless means is shifted into the on-state by the periodic-operation means and that the wireless means is to be shifted into the off-state by the periodic-operation means.

3. A wireless device according to claim 1,
wherein the wireless-state information notified to the center by the notifying means includes time when the wireless means is to be shifted from a present state into the other state between the on-state and the off-state.

4. A wireless device according to claim 1,
wherein the wireless-state information notified to the center by the notifying means includes that the main power of the vehicle is in the on-state when the power detecting means detects that the main power shifts into the on-state and that the main power of the vehicle is in the off-state when the power detecting means detects that the main power of the vehicle shifts into the off-state.

5. A center communicating with a user and a wireless device that is provided in a vehicle and has, for wireless communication, a wireless unit whose operating state being shifted between an on-state and an off-state during an off-state of main power of the vehicle, the center comprising:
determining means for determining whether wireless-state information including information that relates to the operating state of the wireless unit during the off-state of the main power of the vehicle is notified by the wireless device; and
notifying means for notifying to the user the wireless-state information determined to be notified by the determining means.

6. A center according to claim 5,
wherein the notifying means includes:
storing means for storing the wireless-state information determined to be notified by the determining means; and
replying means for notifying to the user the wireless-state information stored in the storing means according to request of the user.

7. A center according to claim 6,
wherein the wireless-state information determined to be notified by the determining means includes that the wireless unit is shifted into the on-state and that the wireless unit is to be shifted into the off-state.

8. A center according to claim 6,
wherein the wireless-state information determined to be notified by the determining means includes time when the wireless means is to be shifted from a present state into the other state between the on-state and the off-state.

9. A center according to claim 6,
wherein the wireless-state information determined to be notified by the determining means includes that the main power of the vehicle is in the on-state and that the main power of the vehicle is in the off-state.

10. A wireless-state notifying system including a wireless device provided in a vehicle and a center that communicates with a user and the wireless device, the wireless-state notifying system comprising:
power detecting means for detecting either of an on-state and an off-state of main power of the vehicle;
wireless means, for wireless communication, having periodic-operation means that shifts an operating state of the wireless means itself between an on-state and an off-state during the off-state of the main power of the vehicle detected by the power detecting means;
center notifying means for notifying to the center wireless-state information including information that relates to the operating state of the wireless means;
notification determining means for determining whether the wireless-state information is notified by the center notifying means; and
user notifying means for notifying to the user the wireless-state information determined by the notification determining means.

11. A wireless device that is provided in a vehicle and communicates with a center that communicates with a user, the wireless device comprising:
power detecting means for detecting either of an on-state and an off-state of main power of the vehicle;
wireless means, for wireless communication, having periodic-operation means that shifts an operating state of the wireless means itself between an on-state and an off-state during the off-state of the main power of the vehicle detected by the power detecting means; and
notifying means for notifying to the user wireless-state information including information that relates to the operating state of the wireless means.

12. A wireless device according to claim 11,
wherein the notifying means notifies, to an identification number of a cell phone of the user, the wireless-state information.

13. A wireless device according to claim 11,
wherein the notifying means notifies, to an identification number of an e-mail of the user, the wireless-state information.

14. A wireless device according to claim 11,
wherein the notifying means notifies, to an identification number of a pager of the user, the wireless-state information.

15. A wireless device according to claim 11,
wherein the notifying means notifies, to an identification number of a facsimile machine of the user, the wireless-state information.

16. A wireless-state notifying method in a system including a wireless device provided in a vehicle and a center that communicates with a user and the wireless device, the wireless-state notifying method comprising steps of:
detecting either of an on-state and an off-state of main power of the vehicle;
shifting an operating state of a wireless communication function in the wireless device between an on-state and an off-state of during the off-state of the main power of the vehicle;
notifying, from the wireless device to the center, wireless-state information including information that relates to the operating state of the wireless communication function; and
notifying, from the center to the user, the wireless-state information.
